(19) United States
(12) Patent Application Publication
(10) Pub. No.: US 2015/0192037 A1
(43) Pub. Date: Jul. 9, 2015

(54) COMBINED CYCLE PLANT FUEL PREHEATING ARRANGEMENT

(71) Applicants: James H. Sharp, Orlando, FL (US); MIchael Scheurlen, Orlando, FL (US); Monica B. Hansel, Melbourne, FL (US)

(72) Inventors: James H. Sharp, Orlando, FL (US); MIchael Scheurlen, Orlando, FL (US); Monica B. Hansel, Melbourne, FL (US)

(21) Appl. No.: 14/147,887

(22) Filed: Jan. 6, 2014

(51) Int. Cl. F01K 23/10; F01K 9/00; F02C 7/224

(52) U.S. Cl. CPC F01K 23/10; F02C 7/224; F01K 9/003

(57) ABSTRACT

A combined cycle plant (10), including: a gas turbine engine (16) having a compressor (18), a combustor (20), and a gas turbine (22); and a heat recovery steam generator (HRSG) (36), a steam turbine (38), working fluid heated by the HRSG and effective to turn the steam turbine, and a blowdown heat transfer arrangement (90, 92, 94, 102, and 104) configured to capture heat present in blowdown water drawn from the working fluid and to transfer the heat to fuel (24) used in the combustor.

### FIELD OF THE INVENTION

The invention relates to preheating of fuel used in a combustor of a gas turbine engine that is part of a combined cycle plant using heat recaptured from blowdown water.

### BACKGROUND OF THE INVENTION

Combined cycle power plants include a topping cycle to generate electrical energy and a bottoming cycle to recover and use heat from the topping cycle The topping cycle may be a Brayton cycle that conventionally includes a gas turbine engine. The bottoming cycle may be a Rankine cycle that conventionally includes a heat recovery steam generator (HRSG) to extract heat energy from the exhaust of the gas turbine engine to heat steam used to power steam turbines that in turn generate electrical energy.

The gas turbine engine combustors may operate on fuel gas or optionally on fuel oil as a backup. There is a thermodynamic benefit if the fuel is preheated and this has normally been accomplished in several ways. Fuel gas may be heated from feedwater drawn from the bottoming cycle, with the location selected based on the desired fuel gas temperature. Alternately, compressed (and therefore heated) air has been drawn from the gas turbine engine and used to preheat the fuel. Since the topping cycle is more efficient than the bottoming cycle there is a net gain in operating efficiency, thereby justifying the loss of efficiency to the bottoming cycle

### BRIEF DESCRIPTION OF THE DRAWINGS

The invention is explained in the following description in view of the drawings that show

FIG. 1 is a schematic representation of a combined cycle plant having an exemplary embodiment of a fuel preheating arrangement.

FIG. 2 is a schematic representation of a combined cycle plant having another exemplary embodiment of a fuel preheating arrangement.

FIG. 3 is a schematic representation of a combined cycle plant having an alternate exemplary embodiment of a fuel preheating arrangement

### DETAILED DESCRIPTION OF THE INVENTION

The present inventors have developed a new arrangement for a combined cycle plant that can be used to preheat fuel used in a gas turbine engine combustor. This arrangement will maintain the improved efficiency of the topping cycle but without the associated decrease in efficiency in the bottoming cycle experienced under the conventional arrangement for heating the fuel. The result is a net gain in overall operating efficiency Specifically, the inventors propose to use heat present in blowdown water, such as that used in any or all of a low pressure (LP) steam drum, an intermediate pressure (IP) steam drum, a high pressure (HP) steam drum, a low pressure kettle boiler, and/or an intermediate pressure kettle boiler, all of which may be associated with the HRSG of the bottoming cycle A typical blowdown flow may be as much as three percent of the total flow entering the drum or kettle boiler depending upon water quality This flow takes its heat energy with it and since the blowdown is conventionally exhausted to the atmosphere or down a drain, the heat energy is lost. By extracting this energy that is otherwise wasted, it is no longer necessary to use HRSG feedwater to heat the fuel as is conventionally done, and the result is an increase in the efficiency of the bottoming cycle, and hence, of the combined cycle plant. Successful implementation of this arrangement first requires the combined cycle plant to be operating at base load or high part load before the waste heat can be harvested. Utilizing the blowdown mixture is particularly advantageous because the blowdown mixture is partially steam and hence contains relatively high amounts of latent heat that can be recovered as the steam condenses. Additionally, the steam can be flashed at pressures above atmospheric which will result in higher steam pressures and temperatures available for heat transfer to the fuel.

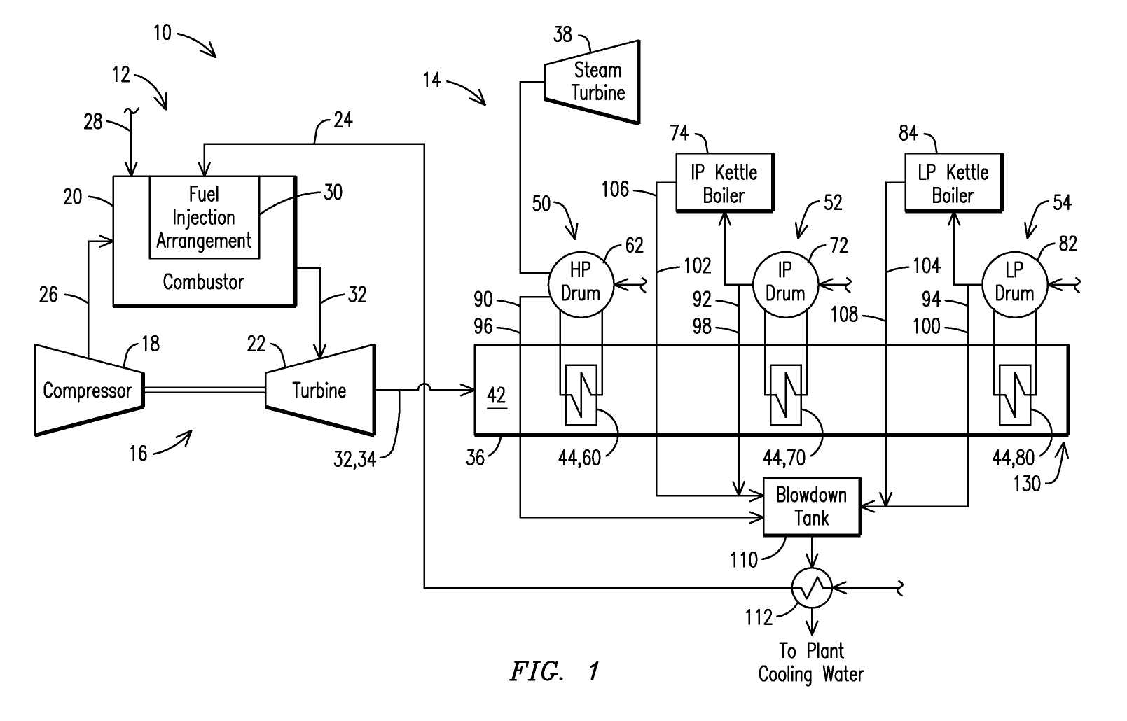

FIG. 1 is a schematic representation of portions of a combined cycle plant 10 having a topping cycle arrangement 12 and a bottoming cycle arrangement 14 The topping cycle arrangement 12 generates a Brayton cycle via a gas turbine engine 16 that includes a compressor 18, a combustor 20, and a turbine 22 The combustor 20 receives fuel 24 from a fuel supply (not shown) and compressed air 26 generated by the compressor 18. The combustor may operate primarily on fuel gas and secondarily on fuel oil. Consequently, either the fuel gas or the fuel oil can be preheated. When operating on fuel oil a diluent 28 may also be used. The fuel 24 may be injected into the combustor 20 via a fuel injection arrangement 30.

The fuel 24 and compressed air 26 combust (optionally with the diluent 28 added for oil operation) and generate a flow of combustion products 32 that flows into the turbine 22 and cause the turbine 22 to rotate This, in turn, turns a generator (not shown) which produces electrical energy. The combustion products 32 expand within the turbine 22 and exit the turbine 22 as exhaust 34. The exhaust 34 still contains valuable heat and much of this heat is recaptured in the bottoming cycle arrangement 14.

The bottoming cycle arrangement 14 generates a Rankine cycle by capturing the heat from the exhaust 34 and generating steam from the captured heat using a heat recovery steam generator (HRSG) 36. The steam is used to turn one or more steam turbines 38 that generate additional electrical energy. The HRSG 36 defines an exhaust path 42 through which the exhaust 34 flows Heat exchangers 44 are distributed in the exhaust path 42 and are effective to capture the heat present in the exhaust 34 and transfer it to a working fluid, such as water. For the purpose of illustration the evaporator sections only are shown; the configuration of superheaters and economizers will vary from plant to plant. There may be multiple stages associated with the bottoming cycle arrangement 14, including any or all of a high pressure (HP) stage 50, an intermediate pressure (IP) stage 52, and a low pressure (LP) stage 54. The HP stage 50 includes a HP heat exchanger 60 and a HP drum 62. Likewise, the IP stage 52 includes an IP heat exchanger 70, an IP drum 72, and an optional IP kettle boiler 74 while the LP stage 54 includes a LP heat exchanger 80, an LP drum 82, and an optional LP kettle boiler 84. The various stages 50, 52, and 54 work together to feed steam to one or more steam turbines 38

Associated with the HP drum 62, the IP drum 72, and the LP drum 82 are an HP drum blowdown arrangement 90, an IP drum blowdown arrangement 92, and a LP drum blowdown arrangement 94 respectively. Likewise, associated with the IP kettle boiler 74, and the LP kettle boiler 84 are an IP kettle boiler blowdown arrangement 102, and a LP kettle boiler blowdown arrangement 104 respectively During operation there is continuous blowdown from the drums 62, 72, 82 and the optional kettle boilers 74 and 84 via these blowdown arrangements and these are effective to remove contaminants left behind when water turns to steam. An HP drum blowdown stream 96 flows from the

HP drum 62. An IP drum blowdown stream 98 flows from the IP drum 72 An LP drum blowdown stream 100 flows from the LP drum 82. An IP kettle boiler blowdown stream 106 flows from the IP kettle boiler 74 Finally, an LP kettle boiler blowdown stream 108 flows from the LP kettle boiler 84. Conventionally, all of the blowdown streams 96, 98, 100, 106, 108 are sent to a blowdown tank 110 where a large amount of heat is lost as steam is vented to atmosphere from the top of the tank. Additionally, the blowdown water and its heat which are also present in the tank are either sent down a drain or the heat is lost when this water is recycled into the plant cooling system. However, the bottoming cycle arrangement 14 disclosed herein includes components used to recapture this heat and preheat the fuel 24 associated with the Brayton cycle.

In the shown exemplary embodiment the HP drum blowdown stream 96 may be sent to a blowdown tank 110 which feeds a solitary heat exchanger 112 configured to draw heat from the blowdown water and transfer it in the form of steam to the fuel 24 associated with the Brayton cycle arrangement 12. Likewise the IP drum blowdown stream 98 may be sent to the blowdown tank 110 and the LP drum blowdown stream 100 may also be sent to the blowdown tank 110 and ultimately to the solitary heat exchanger 112 where the heat is extracted

In a manner similar to the drum blowdown arrangements, one or all of the kettle boiler blowdown arrangements 102 and 104 may transfer their respective streams to the blowdown tank 110 which feeds the solitary heat exchanger 112 Specifically, the IP kettle boiler blowdown stream 106 and the LP kettle boiler blowdown stream 108 would each flow to the blowdown tank 110 and ultimately contribute heat to the fuel 24.

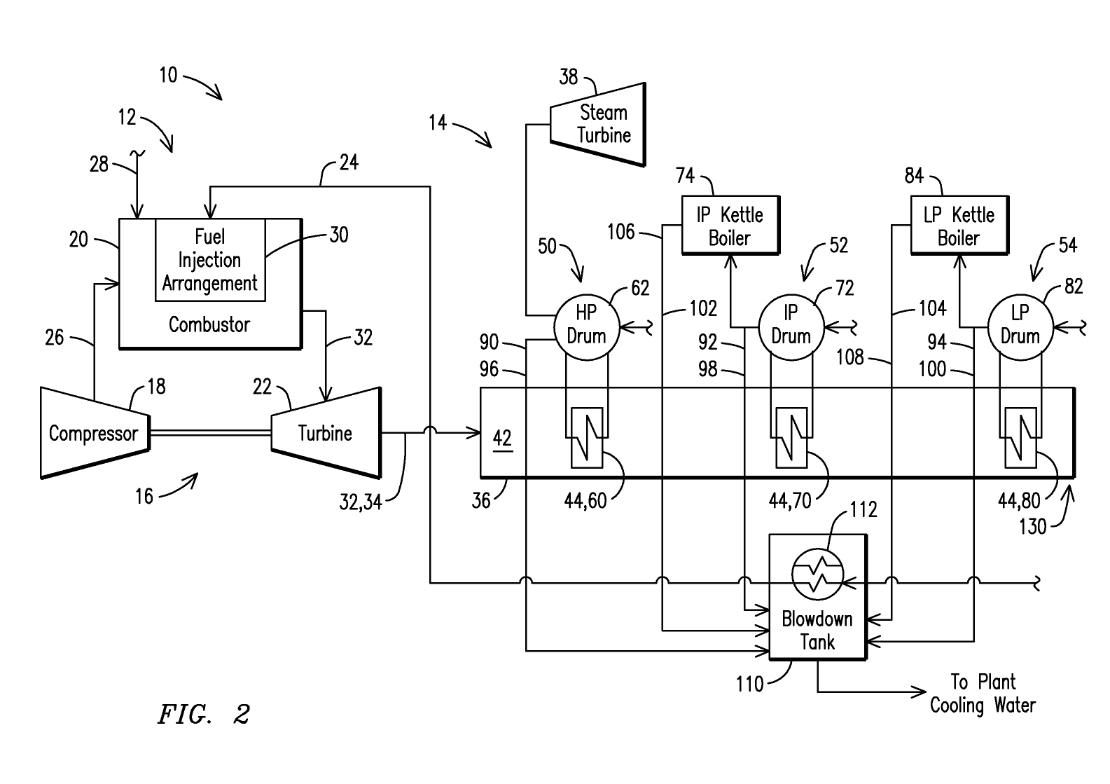

FIG. 2 shows a variation of the exemplary embodiment of FIG. 1, where the blowdown tank 110 and the solitary heat exchanger 112 are combined. In such a configuration the solitary heat exchanger 112 may take the form of coils disposed in the blowdown tank 110. The fuel 24 can flow through the coils while the heat from within the blowdown tank 110 heats the fuel 24 flowing through the coils Such a consolidation may represent an economical manifestation of the disclosures herein.

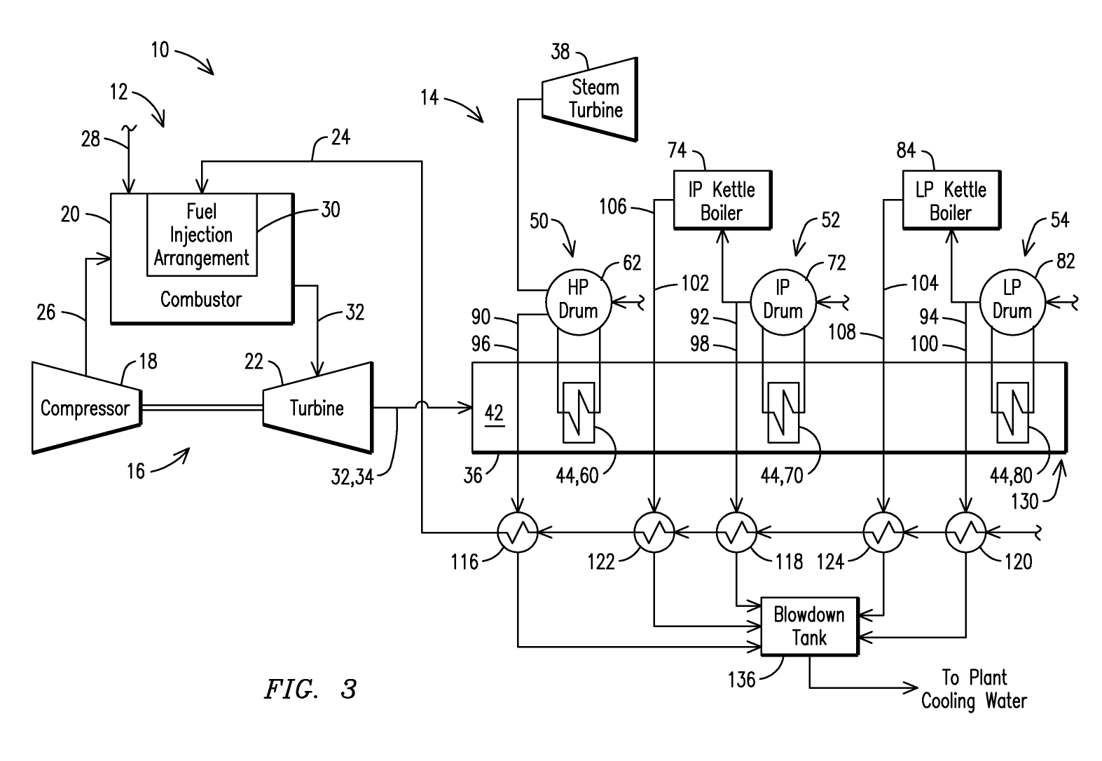

FIG. 3 is a schematic representation of an alternate exemplary embodiment of the combined cycle plant 10 having a topping cycle arrangement 12 and a bottoming cycle arrangement 14. In this exemplary embodiment the HP drum blowdown arrangement 90 may include an HP drum blowdown arrangement heat exchanger 116 configured to draw heat from the HP drum blowdown stream 96 and transfer the heat to the fuel 24 associated with the Brayton cycle arrangement 12. Likewise the IP drum blowdown arrangement 92 includes an IP drum blowdown arrangement heat exchanger 118 configured to draw heat from the IP drum blowdown stream 98 and the LP drum blowdown arrangement 94 includes an LP drum blowdown arrangement heat exchanger 120 configured to draw heat from the LP drum blowdown stream 100.

In a manner similar to the drum blowdown arrangements, one or all of the kettle boiler blowdown arrangements 102 and 104 may have an associated heat exchanger. Specifically, the IP kettle boiler blowdown arrangement 102 includes an IP kettle boiler blowdown arrangement heat exchanger 122 configured to draw heat from the IP kettle boiler blowdown stream 106 and the LP kettle boiler blowdown arrangement 104 includes an LP kettle boiler blowdown arrangement heat exchanger 124 configured to draw heat from the LP kettle boiler blowdown stream 108 After exiting the blowdown arrangement heat exchangers 116, 118, 120, 122 and 124 the blowdown streams 96, 98, 100, 106, and 108 would flow to a conventional blowdown tank 136 where any remaining energy would be flashed and the water recycled into the plant cooling system

In the exemplary embodiment of FIG. 3 any or all of the blowdown heat exchangers may be employed. They may be employed in series as shown. In this way the fuel 24 is heated using gradually hotter blowdown flows. Alternately, only the drum blowdown arrangements 90, 92, 94 could be used and they could be configured serially, or they could be used individually Similarly, only the kettle boiler blowdown arrangements 102 and 104 could be used and they could be configured serially, or they could be used individually Alternately, any combination of blowdown heat exchangers in any flow configuration could be used. Further, while this exemplary embodiment of FIG. 3 shows a blowdown heat exchanger for each blowdown arrangement, any number of heat exchangers may be used for each blowdown arrangement, and not all blowdown arrangements need to have a blowdown heat exchanger.

From the foregoing it can be seen that the present inventors have recognized a source of energy not previously used for fuel heating and developed a way to harvest this heat energy. Taking the energy and applying it as proposed supplants or supplements the prior art's need to draw energy from the bottoming cycle. This improves the efficiency of the bottoming cycle which, in turn, generates an improvement of plant efficiency. Consequently, the arrangement disclosed represents an improvement in the art

While various embodiments of the present invention have been shown and described herein, it will be obvious that such embodiments are provided by way of example only. Numerous variations, changes and substitutions may be made without departing from the invention herein Accordingly, it is intended that the invention be limited only by the spirit and scope of the appended claims

The invention claimed is:

1. A combined cycle plant, comprising:
a gas turbine engine comprising a compressor, a combustor, and a gas turbine; and
a heat recovery steam generator (HRSG) receiving exhaust from the gas turbine, a steam turbine, working fluid heated by the HRSG and effective to turn the steam turbine, and a blowdown heat transfer arrangement configured to capture heat present in blowdown water drawn from the working fluid and to transfer the heat to fuel used in the combustor.

2. The combined cycle plant of claim 1, further comprising a steam drum, and a blowdown arrangement configured to blowdown the steam drum, wherein the blowdown heat transfer arrangement is configured to extract heat from blowdown of the steam drum.

3. The combined cycle plant of claim 2, wherein the steam drum comprises a first pressure steam drum, wherein the combined cycle plant further comprises:
a second pressure steam drum, and
a second blowdown arrangement configured to blowdown the second pressure steam drum, and
wherein the blowdown heat transfer arrangement is configured to transfer heat from blowdown of the first pressure steam drum to the fuel and to transfer heat from blowdown of the second pressure steam drum to fuel heated by the heat from the first pressure steam drum.

4. The combined cycle plant of claim 3, wherein the first pressure steam drum is an intermediate pressure steam drum and the second pressure steam drum is a high pressure steam drum.

5. The combined cycle plant of claim 1, further comprising a kettle boiler, wherein the blowdown heat transfer arrangement is configured to extract heat from blowdown of the kettle boiler

6. The combined cycle plant of claim 1, wherein the fuel comprises a fuel gas.

7. A combined cycle plant, comprising:
a Brayton cycle arrangement comprising a compressor, a combustor and a turbine configured to generate a combustion process;
a fuel injection arrangement configured to inject a fuel into the combustion process; and
a Rankine cycle arrangement configured to receive exhaust from the combustion process; and
a blowdown heat transfer arrangement configured to capture heat produced from a blowdown flow of the Rankine cycle arrangement and to transfer the heat to the fuel.

8. The combined cycle plant of claim 7, wherein the Rankine cycle arrangement comprises a heat recovery steam generator and an associated steam drum, and wherein the blowdown flow is from the associated steam drum.

9. The combined cycle plant of claim 7, wherein the Rankine cycle arrangement comprises a heat recovery steam generator and a steam drum,
wherein the blowdown flow comprises a blowdown flow from the steam drum, and
wherein the blowdown heat transfer arrangement is configured to transfer the heat to the fuel from the blowdown flow from the steam drum.

10. The combined cycle plant of claim 7, wherein the Rankine cycle arrangement comprises a heat recovery steam generator and an associated kettle boiler, and wherein the blowdown flow is from the associated kettle boiler.

11. The combined cycle plant of claim 7, wherein the fuel comprises a fuel gas

12. A combined cycle plant, comprising:
a Brayton cycle arrangement; and
a Rankine cycle arrangement comprising a blowdown arrangement and a blowdown heat transfer arrangement configured to capture heat from the blowdown arrangement and to transfer the heat directly to a fuel associated with the Brayton cycle arrangement.

13. The combined cycle plant of claim 12, wherein the Brayton cycle arrangement comprises a combustor, and wherein the fuel is injected into the combustor.

14. The combined cycle plant of claim 12, wherein the Rankine cycle arrangement comprises a heat recovery steam generator (HRSG) configured to receive exhaust from a gas turbine of the Brayton cycle, and wherein the heat is transferred to the exhaust and is effective to prevent the exhaust from falling below a threshold temperature while within the HRSG.

15. The combined cycle plant of claim 12, wherein the Rankine cycle arrangement comprises a heat recovery steam generator and an associated steam drum, and wherein the blowdown arrangement is configured to blowdown the associated steam drum.

16. The combined cycle plant of claim 12, wherein the Rankine cycle arrangement comprises a heat recovery steam generator and an associated kettle boiler, and wherein the blowdown arrangement is configured to blowdown the associated kettle boiler.

17. The combined cycle plant of claim 12, wherein the fuel comprises a fuel gas
